(19) United States
(12) Patent Application Publication
(10) Pub. No.: US 2003/0152075 A1
(43) Pub. Date: Aug. 14, 2003

(54) Virtual local area network identifier translation in a packet-based network

(76) Inventors: Austin J. Hawthorne III, Wall, NJ (US); Usama Anqud, Sunnyvale, CA (US)

Correspondence Address: Wilson & Ham, PMB: 348, 2530 Berryessa Road, San Jose, CA, 95132, US

(21) Appl. No.: 10/179,733

(22) Filed: Jun. 24, 2002

Related U.S. Application Data
(60) Provisional application No. 60/357,471, filed on Feb. 14, 2002.

(51) Int. Cl. H04L 12/28; H04L 12/54

(52) U.S. Cl. 370/389; 370/400; 370/395.53; 370/428

(57) ABSTRACT

A method and system for forwarding traffic through a network node involve translating a virtual local area network identifier (VLAN ID) of received VLAN traffic from an input VLAN ID to an output VLAN ID (or VLAN IDs) before the traffic is transmitted from the network node. In an embodiment, the input VLAN ID is different from the output VLAN ID. In an embodiment, VLAN ID translation occurs at port interfaces within the network node that receive incoming VLAN traffic. In an embodiment, each port interface can be configured to independently translate input VLAN IDs to output VLAN IDs and output ports.

### CROSS-REFERENCE TO RELATED APPLICATION

This application is entitled to the benefit of provisional Patent Application Serial No. 60/357,471, filed Feb. 14, 2002.

### FIELD OF THE INVENTION

The invention relates generally to a technique for forwarding traffic through a packet-based network, and more particularly, to a technique for forwarding traffic through a packet-based network using virtual local area network (VLAN) technology.

### BACKGROUND OF THE INVENTION

Traditional metropolitan area communications services are based upon technologies such as asynchronous transfer mode (ATM), synchronous optical network (SONET), and Frame Relay technologies, which are optimized for voice communications services. With the increased use of the Internet as a communications medium, non-voice traffic (often referred to as data traffic) is becoming the most prevalent type of network traffic. To meet the increasing demand for data-centric communications services in metropolitan areas, new data-centric metropolitan area networks (MANs) are being built. These new MANs often utilize Ethernet at Layer 2 of the Open System Interconnection (OSI) model to connect nodes within the network (where the OSI model is defined by the International Standardization Organization (ISO)). Ethernet is a popular Layer 2 protocol for use in MANs because of its compatibility with the installed base of end users, its compatibility with the widely used Layer 3 Internet protocol (IP), because of its overall flexibility, and because it is relatively cheap to deploy when compared to other Layer 2 technologies, such as ATM, SONET, and Frame Relay.

Although deploying Ethernet as the Layer 2 technology in MANs has many advantages, the end-user customers, such as businesses, that are targeted to utilize MANs often desire advanced network services such as quality of service (QoS) guarantees, permanent virtual circuits (PVCs), Virtual Leased Lines (VLLs), and transparent LAN services (TLS). Many of these advanced services can be provided by a network that utilizes a Layer 2 technology such as ATM, SONET, or Frame Relay. Ethernet, on the other hand, was not originally designed to provide advanced services and as a result, solutions to customer needs can be more difficult to implement in Ethernet-based networks.

One Ethernet technology that is presently utilized in MANs to provide advanced services to customers is VLAN technology. A VLAN is a group of network devices on different physical LAN segments that can communicate with each other as if they were on the same physical LAN segment. Network devices and their respective network traffic can be mapped into VLAN groups using port-based VLAN mapping, MAC address-based VLAN mapping, protocol-based VLAN mapping, IP subnet-based VLAN mapping, and application-based VLAN mapping, or any combination thereof. The most widely accepted standard for implementing VLANs in an Ethernet network is defined by the IEEE in its 802.1Q standard. Implementing 802.1Q VLANs involves tagging packets with a Tag Control Information field that identifies the VLAN to which the packets belong. According to the 802.1Q standard, the Tag Control Information field includes a 12-bit VLAN Identifier (ID) field that enables VLANs to be uniquely identified.

FIG. 1 depicts a network 102 that utilizes VLAN technology to connect multiple customers 104, 106, and 108 to a Service Provider Network 110. In the example network of FIG. 1, the customers are connected to the Service Provider Network via an Ethernet-based Service Provider Edge Device 112. In an example network architecture, the customers depicted in FIG. 1 are actually metropolitan service providers (MSPs) that are providing network access to multiple end-users (not shown) and the Service Provider Edge Device and Service Provider Network belong to a large scale network provider, such as the regional Bell operating companies (RBOCs) or long-haul network providers.

Using VLAN technology, a customer, for example Customer A 104, can connect to the Service Provider Network 110 using a VLAN. As depicted in the example of FIG. 1, the VLAN Identifier (ID) used by Customer A is VLAN ID 20. In operation, the VLAN traffic from Customer A enters the Service Provider Edge Device 112 at port 1 and the input VLAN ID associated with the traffic is used to quickly and efficiently identify the output port for the VLAN traffic. A fundamental principal of known VLAN technology is that the VLAN on which traffic enters a network node is the same as the VLAN on which the traffic exits the network node. In accordance with this principal, the traffic entering port 1 on VLAN ID 20 exits the Service Provider Edge Device through the target output port (i.e., port 5) on the same VLAN ID (i.e., VLAN ID 20) on which the traffic enters the Service Provider Edge Device. VLAN traffic is always kept on the same VLAN because switching traffic to a different VLAN within a network node removes the traffic from the group to which the traffic was originally associated.

Although VLAN technology works well to provide some advanced services in a MAN environment, VLAN technology has limitations. A significant limitation of VLAN technology that utilizes the 802.1Q VLAN standard is that the length of the VLAN ID field in the 802.1Q VLAN tag is 12 bits. Consequently, any network in which VLANs are deployed is limited to 4,096 unique VLAN IDs (actually, the number of unique VLAN IDs is limited to 4,094 because the value of all ones (0×FFF) is reserved and the value of all zeros (0×000) indicates a priority tag). Because the redundant use of VLAN IDs in the same network should be avoided, the limited number of unique VLAN IDs that are possible using the 12-bit VLAN ID field limits the scalability of a network that utilizes 802.1Q VLANs.

In the example network of FIG. 1, problems of limited scalability and redundant use of VLAN IDs can arise when Customers B and C 106 and 108 want to forward traffic through the Service Provider Edge Device 112 to the Service Provider Network 110 using the same VLAN ID (i.e., VLAN ID 20) as the VLAN ID that is being used by Customer A 104. If the traffic from all three of the customers is output on the same port of the Service Provider Edge Device with the same VLAN ID, the customer-specific traffic cannot be differentiated within the Service Provider Network based on VLAN ID alone and as a result additional packet processing must be performed within the service provider network to prevent different customers from seeing each other's traffic. In order to avoid additional packet processing and to prevent VLAN traffic from being seen by the wrong customers, each VLAN ID within the network should be unique from all of the other VLAN IDs that are used in the network.

One technique that can be implemented to prevent the same VLAN ID from being used by more than one customer within a network involves having the operator of the Service Provider Edge Device (i.e., the Service Provider) administer the assignment of VLAN IDs to the customers. Having VLAN IDs administered by a Service Provider is undesirable because customers typically want the freedom to establish VLANs and assign VLAN IDs independent of their Service Provider.

Even if the assignment of VLAN IDs is administered by a Service Provider, the number of VLANs that can be assigned cannot scale beyond 4,096 without the redundant use of VLAN IDs. The redundant use of VLAN IDs can be prevented by limiting each customer to some portion of the 4,096 available VLAN IDs, however this limits the ability of the customers to deploy VLAN intensive applications.

In view of the need to provide VLAN-based services using an Ethernet network architecture and in view of the scalability limitations of present VLAN technologies, what is needed is a VLAN technology with greater scalability that can be efficiently and economically implemented.

### SUMMARY OF THE INVENTION

A method and system for forwarding traffic through a network node involve translating a virtual local area network identifier (VLAN ID) of received VLAN traffic from an input VLAN ID to an output VLAN ID (or VLAN IDs) before the traffic is transmitted from the network node. In an embodiment, VLAN ID translation occurs at port interfaces within the network node that receive incoming VLAN traffic. In an embodiment, each port interface can be configured to independently translate input VLAN IDs to output VLAN IDs and output ports. For example, VLAN ID translation is accomplished by mapping input VLAN IDs to the appropriate output VLAN IDs.

Performing VLAN ID translation on a per-port interface basis enables the entire range of VLAN ID values to be unique to each port interface. That is, each port interface can utilize the full range of available VLAN IDs independently of the other port interfaces as long as input VLAN IDs and output VLAN IDs are associated with each other by VLAN ID translation rules. The use of VLAN ID translation enables network nodes that implement 802.1Q VLANs to be scaled beyond 4,096 unique VLANs.

An embodiment of a method for forwarding traffic through a network node includes receiving traffic at the network node, the traffic that is received at the network node being identified by an input VLAN ID as belonging to a first VLAN; translating the input VLAN ID to an output VLAN ID; and transmitting the traffic from the network node, the traffic that is transmitted from the network node being identified by the output VLAN ID as belonging to a second VLAN.

In an embodiment, the output VLAN ID is different from the input VLAN ID.

In another embodiment, the input VLAN ID is included within a first set of port-specific VLAN IDs and the output VLAN ID is included within a second set of port-specific VLAN IDs. In an further embodiment, the first set of port-specific VLAN IDs is independent of the second set of port-specific VLAN IDs.

In another embodiment, the method includes programming a hardware-based look-up table that maps the input VLAN ID to the output VLAN ID such that translating the input VLAN ID to the output VLAN ID involves accessing the hardware-based look-up table and using the input VLAN ID as search criteria to identify the output VLAN ID.

In another embodiment, translating the input VLAN ID to the output VLAN ID includes obtaining the input VLAN ID from 802.1Q headers of the received traffic and transmitting the traffic from the network node includes embedding the output VLAN ID into 802.1Q headers of outgoing traffic, wherein 802.1Q is a VLAN protocol that is defined by the IEEE.

An embodiment of a network node includes an input port interface configured to receive traffic, the traffic that is received at the input port interface being identified by an input VLAN ID as belonging to a first VLAN; a VLAN ID translation engine configured to translate the input VLAN ID to an output VLAN ID; and an output port interface configured to transmit the traffic, the traffic that is transmitted from the output port interface being identified by the output VLAN ID as belonging to a second VLAN.

In an embodiment of the network node, the output VLAN ID is different from the input VLAN ID.

In another embodiment of the network node, the input port interface is associated with a first set of port-specific VLAN IDs and the output port interface is associated with a second set of port-specific VLAN IDs, the first set of port-specific VLAN IDs being independent of the second set of port-specific VLAN IDs.

In another embodiment of the network node, the VLAN ID translation engine includes a hardware-based table associated with the input port interface, the hardware-based table including a table entry that identifies the output VLAN ID and the output port interface as a function of the input VLAN ID.

Other aspects and advantages of the present invention will become apparent from the following detailed description, taken in conjunction with the accompanying drawings, illustrating by way of example the principles of the invention.

### BREIF DESCRIPTION OF THE DRAWINGS

FIG. 1 depicts a network arrangement that utilizes VLAN technology to connect multiple customers to a Service Provider Network as is known in the prior art.

FIG. 2 depicts an example of a network node that translates the VLAN ID of received VLAN traffic from an input VLAN ID to an output VLAN ID before the traffic is transmitted from the network node in accordance with an embodiment of the invention.

FIG. 3 depicts an expanded view of a port interface in relation to the switch fabric and control module of a network node.

FIG. 4 depicts an example embodiment of the L2 processor and the Control Module from FIG. 3 that includes functional elements that are related to VLAN ID translation in accordance with an embodiment of the invention.

FIG. 5 depicts an example of the relationship between software-based and hardware-based forwarding information in a VLAN ID translation engine in accordance with an embodiment of the invention.

FIG. 6 depicts an example pseudo-packet that includes a pseudo-header and a payload, with the pseudo-header including a translated VLAN ID in accordance with an embodiment of the invention.

FIG. 7 depicts an example of an L2 processor at an output port interface of the network node that includes a frame generator.

FIG. 8 depicts an example application of VLAN ID translation that ensures the uniqueness of VLAN traffic when the same VLAN ID is used for traffic at more than one port of the network node in accordance with an embodiment of the invention.

FIG. 9 depicts an example of the scalability that is enabled by the VLAN ID translation techniques that are described with reference to FIGS. 2-8.

FIG. 10 depicts an example of VLAN traffic that is aggregated on a per-port, or per-customer, basis using VLAN ID translation in accordance with an embodiment of the invention.

FIG. 11 depicts an example of VLAN traffic that is aggregated and segregated using VLAN ID translation in accordance with an embodiment of the invention.

FIG. 12 depicts an example of an end-to-end VLAN implementation that is enabled via the VLAN ID translation techniques that are described above with reference to FIGS. 2-7 in accordance with an embodiment of the invention.

FIG. 13 depicts another example of an end-to-end VLAN implementation that is enabled via VLAN ID translation in accordance with an embodiment of the invention.

FIG. 14 depicts an example of how VLAN ID translation can be used to scale the number of unique VLAN IDs that are available between a customer and a service provider edge device in accordance with an embodiment of the invention.

FIG. 15 is a process flow diagram of a method for forwarding traffic through a network node in accordance with an embodiment of the invention.

FIG. 16 is a process flow diagram of another method for forwarding traffic through a network node in accordance with an embodiment of the invention.

FIG. 17 is a process flow diagram of another method for forwarding traffic through a network node in accordance with an embodiment of the invention.

### DETAILED DESCRIPTION OF THE INVENTION

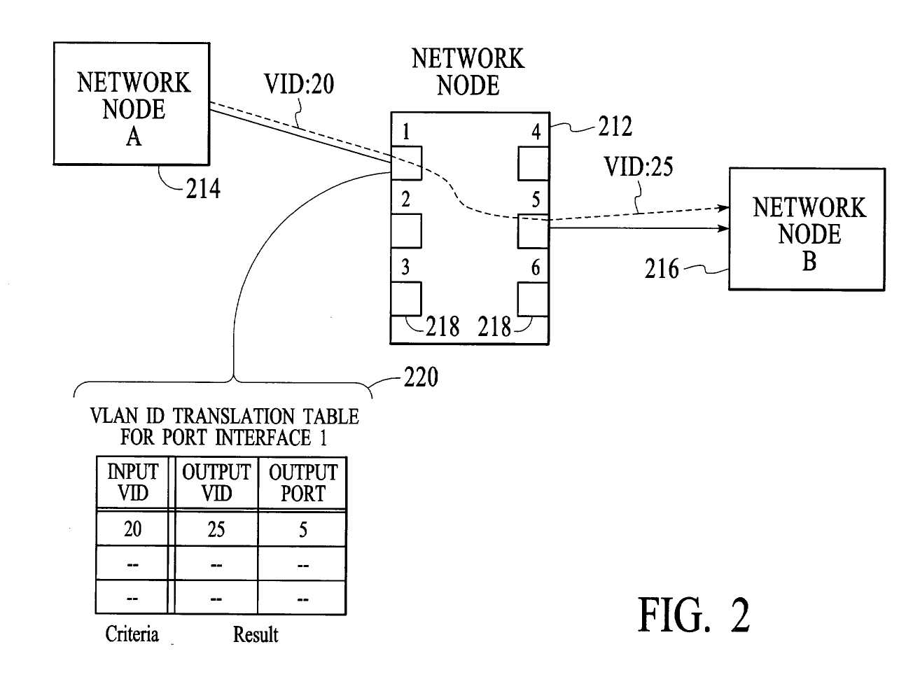

FIG. 2 depicts an example of a network node 212 that translates the virtual local area network identifier (VLAN ID) of received VLAN traffic from an input VLAN ID to an output VLAN ID before the traffic is transmitted from the network node. In the embodiment of FIG. 2, the network node is an Ethernet switch/router that forwards traffic within the network node using Layer 2, Layer 3, and/or Layer 4 header information. The network node includes six port interfaces 218, with Port Interface 1 being connected to Network Node A 214 and Port Interface 5 being connected to Network Node B 216. In the example of FIG. 2, VLAN traffic received on an input VLAN ID of 20 is translated to an output VLAN ID of 25.

In accordance with an embodiment of the invention, the network node 212 depicted in FIG. 2 includes the functionality to translate an input VLAN ID to an output VLAN ID. In an embodiment, the network node utilizes a VLAN ID translation table that maps input VLAN IDs to the appropriate output VLAN IDs. In operation, input VLAN IDs are used as criteria to search the VLAN ID translation table and the results are corresponding output VLAN IDs. When implemented in a multiport network node such as the network node depicted in FIG. 2, the VLAN ID translation table maps input VLAN IDs to output VLAN ID and output port pairs. FIG. 2 includes a logical depiction of an example VLAN ID translation table 220 related to Port Interface 1. The VLAN ID translation table maps input VLAN IDs (search “criteria”) to output VLAN and output port pairs (search “result”). In the given example, the VLAN ID translation table maps input VLAN ID 20 to output VLAN ID 25 and output port 5. In an embodiment, the VLAN ID translation table is implemented as a hardware-based table that maps an input VLAN to a translated VLAN ID and an output port. Although only a single entry is shown in the VLAN ID translation table of FIG. 2, the table may include additional entries. In addition, although in the example of FIG. 2 VLAN traffic is mapped to a single output port, VLAN traffic could also be mapped to multiple output ports.

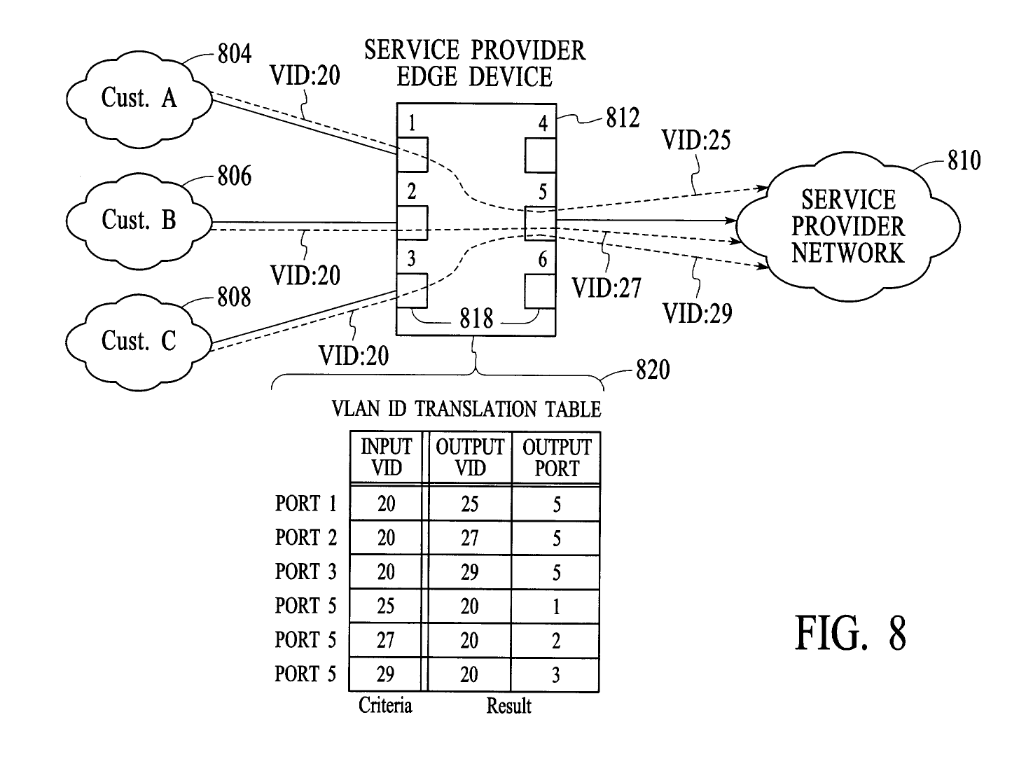

In the embodiment of FIG. 2, VLAN ID translation occurs at the port interfaces 218 that receive incoming VLAN traffic. For example, each port interface can be configured to independently translate input VLAN IDs to output VLAN IDs and output ports. Because VLAN ID translation is done on a per-port interface basis, the entire range of VLAN ID values can be considered as unique to each port interface. That is, each port interface can utilize the full range of available VLAN IDs independently of the other port interfaces as long as input VLAN IDs and output VLAN IDs are associated with each other by VLAN ID translation rules. The use of VLAN ID translation enables network nodes that implement 802.1Q VLANs to be scaled beyond 4,096 unique VLANs. An example of the scalability enabled by VLAN ID translation is described below with reference to FIG. 8.

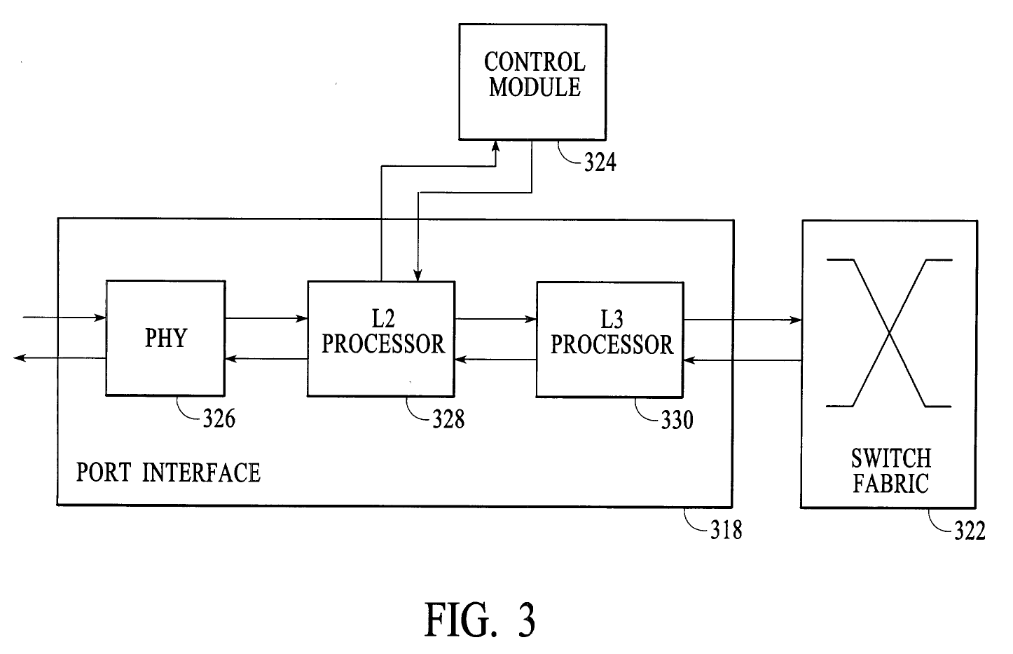

In addition to the port interfaces, in an embodiment, the network node depicted in FIG. 2 includes control logic that is incorporated into a control module (not shown) and switching logic that is incorporated into a switch fabric (not shown). FIG. 3 depicts an expanded view of a port interface 318 in relation to the switch fabric 322 and control module 324 of a network node. The port interface of FIG. 3 includes a physical layer interface (PHY) 326, an L2 processor 328, and an L3 processor 330. The PHY manages the transmit and receive functions between network nodes. On the transmit side, the PHY encodes digital data into electrical or optical signals and on the receive side, the PHY decodes electrical or optical signals into digital data. The PHY is a well known functional unit and is not described further. In an embodiment, a port interface may include more than one port. For example, a port interface may include a 10 gigabit Ethernet (GbE) optical port, two 1 GbE optical ports, or ten 100 megabit Ethernet (MbE) ports. Although FIG. 3 depicts a single PHY, if the port interface includes more than one port, typically, each port is supported by a dedicated PHY.

In addition, the port interface 318 may be compatible with other network protocols that operate below the Ethernet protocol. For example, port interface may be compatible with ATM, SONET, or Frame Relay. When traffic is received at the port interface in a format other than Ethernet, the traffic is converted to an Ethernet compatible format for processing as described below.

The L2 processor 328 manages the L2 processing and forwarding functions of the network node. For example, the L2 processor manages L2 bridging/switching functions.

The L3 processor 330 manages the L3 processing and forwarding functions of the network node. For example, the L3 processor manages L3 routing functions.

In the embodiment of FIG. 2, the L2 and L3 processors 328 and 330 may include processing logic and memory. The processing logic may be embodied in multifunction processors and/or application specific processors that are operationally connected to the memory. The memory may include circuits for storing operational code, for buffering traffic, and for storing data structures. Operational code is typically stored in non-volatile memory such as electrically erasable programmable read-only memory (EEPROM) or flash ROM while traffic and data structures are typically stored in volatile memory such as random access memory (RAM). Example data structures that are stored in the RAM include configuration state information and traffic forwarding information. Forwarding information may also be stored in content addressable memory (CAM) or a combination of CAM and RAM. Although the PHY 326, L2 processor, and L3 processor are depicted in FIG. 2 as separate devices (i.e., separate IC devices), the functional units may alternatively be partially or fully integrated onto a single device or multiple devices.

The switch fabric 322 provides datapaths between input port and output port interfaces of the network node and may include, for example, shared memory, shared bus, and crosspoint matrices. The switch fabric is a well known functional unit and is not described further.

The control module 324 supports various functions of the network node, such as network management functions and protocol implementation functions. Example network management functions that are performed by the control module include implementing configuration commands, providing timing control, programming hardware tables, providing system information, supporting user interfaces, managing hardware changes, and bus management. Example protocols that are implemented by the control module include Layer 2 (L2) protocols, such as L2 Learning, VLAN management, STP, and LACP and Layer 3 (L3) protocols such as OSPF, BGP, and ISIS. The control module may include a processor and memory for carrying out the designated functions. The processor within the control module may include a multifunction microprocessor and/or an application specific processor that is operationally connected to the memory. The memory within the control module may include EEPROM or flash ROM for storing operational code and DRAM for buffering traffic and storing data structures. Although the control module is depicted as distinct from the port interface, in alternative embodiments, the control module and/or any functions performed by the control module may be included with the port interface.

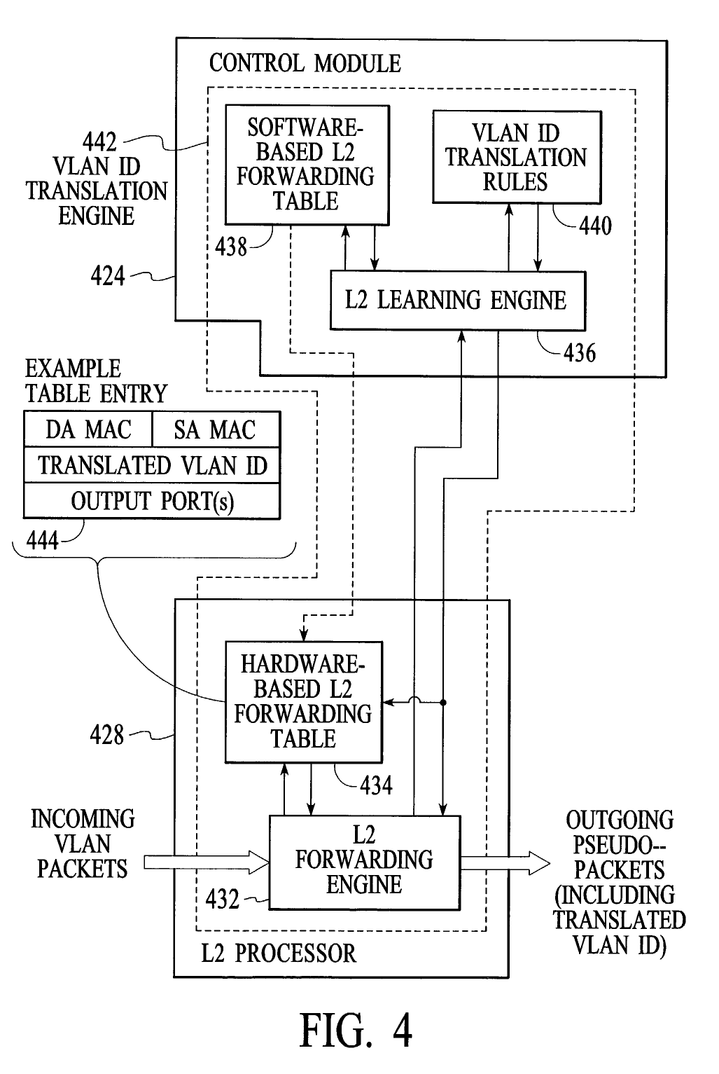

FIG. 4 depicts an example embodiment of the L2 processor 328 and the control module 324 from FIG. 3 that includes functional elements that are related to VLAN ID translation. Referring to FIG. 4, the functional elements within the L2 processor 428 include an L2 forwarding engine 432 and a hardware-based L2 forwarding table 434. The functional elements within the control module 424 include an L2 learning engine 436, VLAN ID translation rules 438, and a software-based L2 forwarding table 440. The aforementioned functional elements depicted within the control module and the L2 processor combine to form an embodiment of a VLAN ID translation engine as indicated by the dashed box 442. Each of the functional elements is described separately herein followed by a description of the operation of the VLAN ID translation engine as a whole. Throughout the description, similar reference numbers may be used to identify similar elements.

With reference to the L2 processor 428, the L2 forwarding engine 432 makes the L2 forwarding decisions for incoming traffic. With regard to incoming VLAN traffic, the L2 forwarding engine uses the input VLAN ID of the VLAN traffic to determine the output VLAN ID for the VLAN traffic. In embodiments with more than one possible output port, the L2 forwarding engine uses the input VLAN ID to determine the output VLAN ID and output port for incoming VLAN traffic.

The hardware-based L2 table 434 contains an ordered data structure of table entries. The table entries include forwarding information that is used to forward traffic through the network node. An example table entry 444 is depicted for description purposes. As depicted in FIG. 4, the forwarding information within each table entry includes a MAC address (typically the destination address MAC address or “DA MAC”), a translated VLAN ID, and an output port or ports. The table entry may also include a field for the source address MAC or “SA MAC.” The table entries are stored in memory and can be located according to their memory address. In the embodiment of FIG. 4, the hardware-based L2 forwarding table and its respective table entries are specific to the respective port interface. In an embodiment, when there are multiple ports on a single port interface, each port has its own port-specific hardware-based L2 forwarding table.

With reference to the control module 424, the L2 learning engine 436 manages L2 learning for all of the port interfaces and maintains the learned forwarding rules for all of the port interfaces in the software-based L2 forwarding table 438. Forwarding rules that are specific to each port interface can be programmed into the respective hardware-based forwarding tables to enable hardware-based forwarding. Hardware-based forwarding is generally preferred over software-based forwarding because hardware-based forwarding increases the speed of packet processing and thereby increases the throughput capacity of the network node.

The software-based L2 forwarding table 438 that is maintained within the control module 424 includes a database structure of table entries that is stored in software. The table entries include forwarding information that is used to forward traffic through the network node. The table entries may include source and destination MAC address information, output port information, VLAN information, and QoS information. In the embodiment of FIG. 4, the table entries for VLAN ID translation traffic include the translated VLAN ID and the target output port. In general, software-based forwarding tables are more flexible than hardware-based forwarding tables however it typically takes longer to search a software-based forwarding table than it does to search a hardware-based forwarding table and therefor the throughput capacity achieved with software-based forwarding is typically less than with hardware-based forwarding. In an embodiment, the software-based forwarding table includes table entries for all of the port interfaces of the network node while the hardware-based forwarding tables include table entries that are specific to the respective port interfaces.

The VLAN ID translation rules 440 functional element includes the VLAN ID translation rules for the network node. The VLAN ID translation rules specify the desired relationships between input VLAN IDs and output VLAN IDs. In an embodiment, the VLAN ID translation rules specify an input port and VLAN ID pair that translate to an output port and VLAN ID pair. By specifying VLAN ID translation rules between input port and VLAN ID pairs and output port and VLAN ID pairs, the uniqueness of VLAN IDs can be established on a per-port basis. In alternative embodiments, the VLAN ID translation rules may include additional criteria. For example, VLAN ID translation rules may specify criteria such as a DA MAC and/or an SA MAC. The VLAN ID translation rules can be manually input into the network node, for example, by a network administrator through an application programming interface (API). Typically, the VLAN ID translation rules are static rules that are changed only by subsequent manual inputs. In an alternative embodiment, VLAN ID translation rules may be automatically established using customized VLAN management algorithms.

An example operation of VLAN ID translation is described below with reference to the functional elements depicted in FIGS. 3 and 4. Network traffic is received at a network node through the port interface 318. The PHY 326 decodes incoming traffic and passes the traffic on to the L2 processor 328 and 428. The L2 processor determines whether or not the traffic belongs to a VLAN, that is, whether or not the traffic is VLAN traffic. If the traffic is determined to be VLAN traffic, the VLAN ID of the traffic is determined. Determination of the VLAN ID depends on whether the traffic is tagged or untagged VLAN traffic. The VLAN ID of untagged VLAN traffic is determined by application of a VLAN association rule. Example VLAN association rules may include port-based VLAN association, MAC address-based VLAN association, protocol-based VLAN association, IP subnet-based VLAN association, and application-based VLAN association, or any combination thereof. The corresponding VLAN ID of tagged VLAN traffic is determined by reading the VLAN ID field of the VLAN tag. For example, the VLAN ID of traffic formatted according to the 802.1Q protocol is determined by reading the 12-bit VLAN ID that is located in the 2-byte Tag Control Information field.

With regard to VLAN traffic, the L2 forwarding engine 432 uses the input VLAN ID of the traffic to determine the respective output VLAN ID and output port for the traffic. If the VLAN ID translation rule for the respective traffic has already been programmed into the hardware-based L2 forwarding table 434 of the port interface, then the output VLAN ID and output port information can be obtained at the port interface by searching the hardware-based L2 forwarding table. Searching the hardware-based forwarding table is a relatively fast operation that involves using the input VLAN ID as criteria to identify the memory location of the desired table entry and obtaining the translated VLAN ID (the output VLAN ID) and the output port information from the table entry. In an embodiment, the hardware-based forwarding table is searched by hashing into the hardware-based L2 forwarding table using the input VLAN ID and the destination MAC address as criteria to identify the location in memory of the desired table entry. Once the desired table entry is identified, the translated VLAN ID that is stored as part of the table entry is attached to the traffic and the traffic is forwarded to the identified output port(s).

If the VLAN ID translation rule for the respective traffic has not already been programmed into the hardware-based L2 forwarding table 434, then searching the hardware-based L2 forwarding table will result in an “L2 miss.” L2 misses occur when the forwarding rules related to traffic have not been learned before the traffic arrives at the port interface. In the case of an L2 miss, a hardware-based forwarding decision cannot be made for the respective traffic at the port interface. In response to an L2 miss, the L2 forwarding engine 432 refers to the L2 learning engine 436 to determine how to forward the traffic. With respect to VLAN traffic, the L2 learning engine will search the software-based L2 table for a corresponding table entry. If a corresponding table entry is located, then the forwarding information is provided to the L2 forwarding engine and the L2 forwarding engine attaches the translated VLAN ID to the traffic and forwards the traffic to the output port that is identified in the table entry. In an embodiment, the table entry found in the software-based forwarding table is programmed into the hardware-based forwarding table so that forwarding decisions for subsequent traffic having the same VLAN ID can be made at the L2 processor 428 utilizing a hardware-based look-up.

If there is no corresponding table entry in the software-based L2 forwarding table 438 for the VLAN traffic, then the L2 learning engine 436 will check the VLAN ID translation rules 440 to see if a VLAN ID translation rule has been established for the respective VLAN ID and input port pair. If a VLAN ID translation rule has been established for the VLAN traffic, then the rule will be provided to the L2 forwarding engine 432 and the L2 forwarding engine will attach the translated VLAN ID to the traffic and forward the traffic to the output port that is identified by the VLAN ID translation rule. In an embodiment, upon learning the new VLAN ID translation rule, the L2 learning engine programs the VLAN ID translation rule into the software-based L2 forwarding table 438. In addition, the VLAN ID translation rule is programmed into the hardware-based L2 forwarding table 434 of the respective port interface so that forwarding decisions for subsequent traffic having the same input port and VLAN ID combination can be made at the L2 processor utilizing a hardware-based look-up.

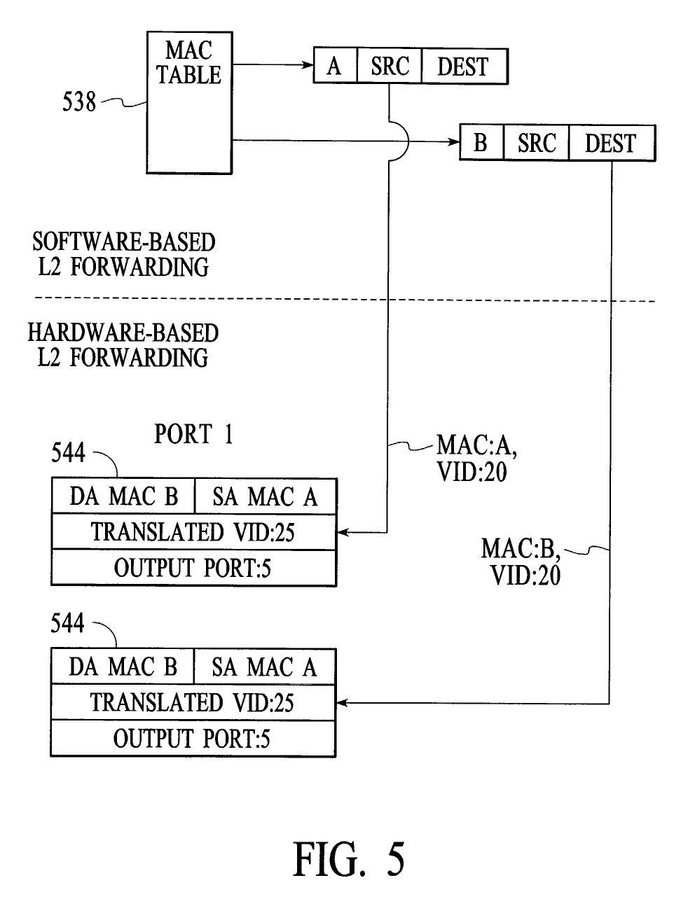

FIG. 5 depicts an example of the relationship between software-based and hardware-based forwarding information for the VLAN ID translation rule that is described with reference to FIG. 2. In the example of FIG. 5, at the software level, a MAC table includes entries for the SA MAC (assuming network node A has an SA MAC of “A”) and the destination MAC address (assuming network node B has a DA MAC of “B”). At the hardware level, table entries are installed for the SA MAC and the DA MAC. The table entries identify MAC addresses, the translated VLAN ID, and the target output port(s). In an embodiment, the desired table entry is identified in the hardware table by hashing on the MAC address (either SA or DA) and the input VLAN ID. As depicted in FIG. 5, hashing into the hardware-based forwarding table based on the DA MAC (i.e., B) and the input VLAN ID (i.e., VLAN ID 20) yields the table entry contains the translated VLAN ID (i.e., VLAN ID 25) and the output port (i.e., 5). Note that the VLAN ID in the destination table entry contains the translated VLAN ID, while the hashing occurs on the original input VLAN ID. In an embodiment, the hardware gets the translated VLAN ID from the destination entry and not the source entry. In an embodiment, it does not matter what VLAN ID is programmed into the SA MAC entry, however, for consistency, the translated VLAN ID is also programmed into the SA MAC entry.

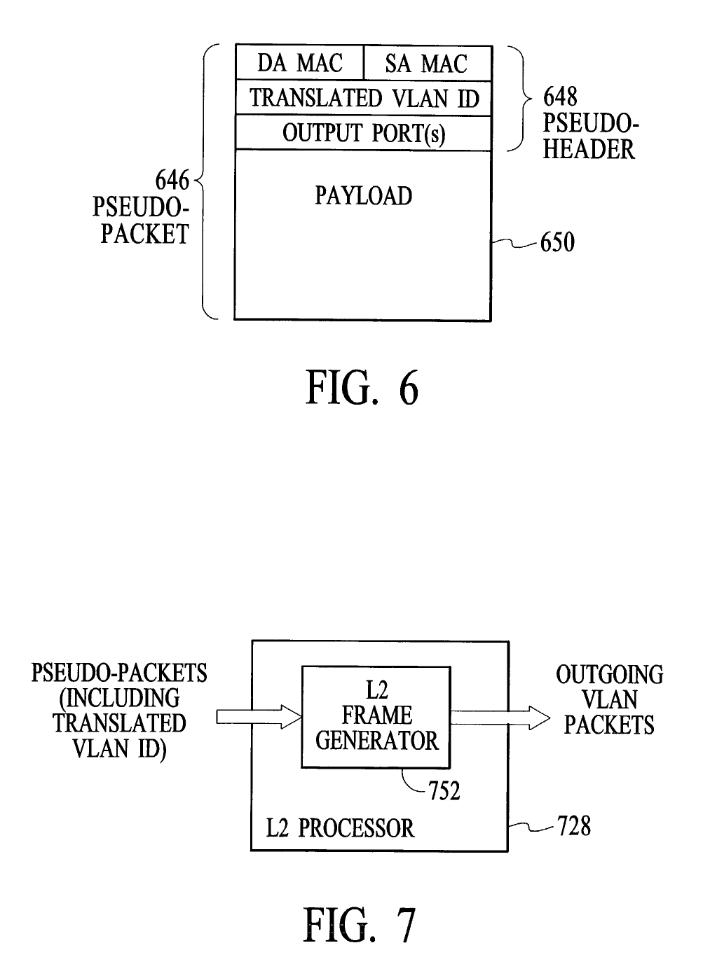

In the embodiment of FIG. 4, incoming VLAN traffic is formatted as Ethernet (or Ethernet compatible) packets when the traffic enters the L2 processor 428. As depicted in FIG. 4, after the above-described forwarding information (i.e., the translated VLAN ID and the output port(s)) is determined for the traffic, the traffic is formatted into pseudo-packets for forwarding through the network node. In an embodiment, each pseudo-packet includes a payload portion that carries the original payload of the incoming packet and an internal switch header (also referred to as a pseudo-header) that carries information specific to forwarding the packet through the network node. Included within the pseudo-header is the translated VLAN ID that was determined by the VLAN ID translation engine 442. FIG. 6 depicts an example pseudo-packet 646 that includes a pseudo-header 648 and a payload 650. The example pseudo-header supports VLAN ID translation and includes fields for identifying the SA MAC address, the DA MAC address, the translated VLAN ID, and the output port(s) of the attached payload. Although only four fields of the pseudo-header are shown, other fields, for example, QoS fields, may be included in the pseudo-header.

Before packets are transmitted from the network node, the pseudo-packets are returned to a standard frame format. In an embodiment, pseudo-packets are returned to a standard frame format, such as an Ethernet frame, at an output port interface. FIG. 7 depicts an example of an L2 processor 728 at an output port interface of the network node. The L2 processor includes an L2 frame generator 752 that transforms pseudo-packets into standard Ethernet (or Ethernet compatible) packets. With regard to VLAN ID translation, the L2 frame generator strips the pseudo-header from the packet, uses the translated VLAN ID that is carried in the pseudo-header to identify the VLAN ID to which the packet belongs, and uses the DA MAC address to determine the L2 destination of the packet. If the VLAN traffic is tagged VLAN traffic (i.e., 802.1Q traffic), the outgoing packet is formatted according to the VLAN protocol and tagged with the translated VLAN ID that was carried in the pseudo-header.

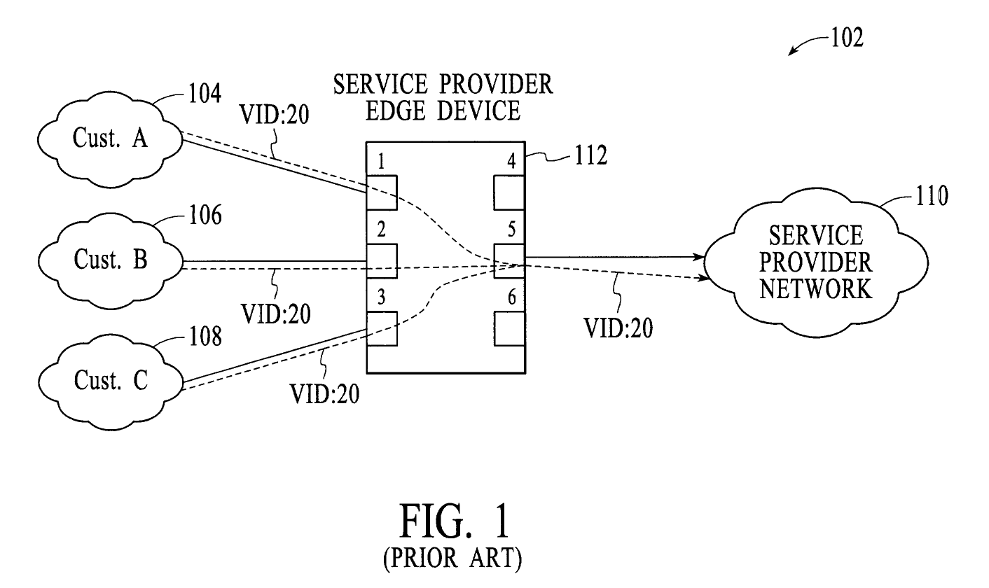

FIG. 8 depicts an example application of VLAN ID translation that ensures the uniqueness of VLAN traffic when the same VLAN ID is used for traffic at more than one port of a network node. As described above with reference to FIG. 1, different customers connected to different ports of a service provider edge device may 812 independently use the same VLAN IDs to send traffic to the service provider edge device. Using VLAN ID translation as described above, the uniqueness of VLAN IDs can be ensured on a per-port basis even if the same VLAN ID is used at more than one port. For example, Customers A, B, and C 804, 806, 808 may send VLAN traffic to the service provider edge device on VLAN ID 20, with the next hop for the VLAN traffic from each customer being to the service provider network 810 via port interface 5 of the service provider edge device. Applying the VLAN ID translation rules depicted in the VLAN ID translation table 820 of FIG. 8, the uniqueness of each customer's VLAN traffic is maintained at the output port interface. For example, the VLAN ID translation rule at port interface 1 translates input VLAN ID 20 to output VLAN ID 25 and output port 5, the VLAN ID translation rule at port interface 2 translates input VLAN ID 20 to output VLAN ID 27 and output port 5, and the VLAN ID translation rule at port interface 3 translates input VLAN ID 20 to output VLAN ID 29 and output port 5. At port 5 of the service provider edge device, the VLAN traffic from customers A, B, and C is transmitted as tagged VLAN traffic on VLAN IDs 25, 27, and 29, respectively. Because the VLAN traffic from each input port interface is sent out port interface 5 on different VLAN IDs, the traffic that is sent from port interface 5 can be differentiated within the service provider network based on VLAN ID alone.

In addition to implementing VLAN ID translation for traffic from the customer 804, 806, and 808 to the service provider network 810, VLAN ID translation can be implemented for traffic in the reverse direction from the service provider network to the customers. For example, VLAN traffic received by the service provider edge device 812 at port interface 5 on VLAN ID 25 can be translated to VLAN ID 20 and port interface 1. Likewise, VLAN traffic received by the service provider edge device at port interface 5 on VLAN ID 27 can be translated to VLAN ID 20 and port interface 2 and VLAN traffic received by the service provider edge device at port interface 5 on VLAN ID 29 can be translated to VLAN ID 20 and port interface 3.

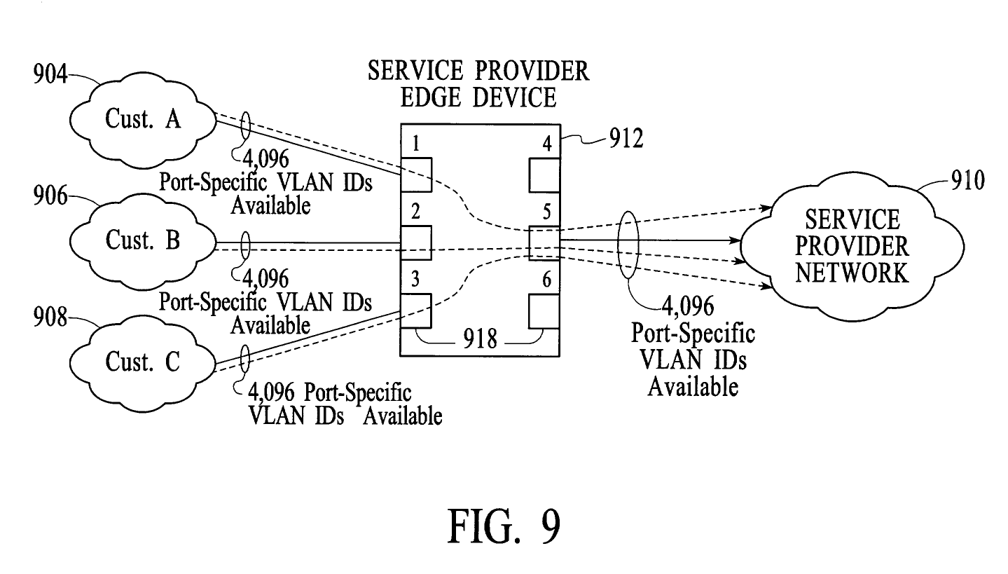

FIG. 9 depicts an example of the scalability that is enabled by the VLAN ID translation techniques that are described with reference to FIGS. 2-8. As depicted in FIG. 9, a service provider edge device 912 includes six port interfaces 918, with port interface 1 connected to Customer A 904, port interface 2 connected to customer B 906, port interface 3 connected to customer C 908, and port interface 5 connected to a service provider network. By implementing VLAN ID translation, each port interface of the network node can independently support the use of the maximum number of VLAN IDs at each port while maintaining the uniqueness of all VLAN traffic within the switch. Specifically, when using 802.1Q VLANs in the example of FIG. 9, port interface 1 can support 4,096 port-specific VLAN IDs from customer A, port interface 2 can support 4,096 port-specific VLAN IDs from customer B, and port interface 3 can support 4,096 port-specific VLAN IDs from customer C. Likewise, on the service provider side of the network node, port interface 5 can support 4,096 port-specific VLAN IDs. In the example of FIG. 9, each set of port-specific VLAN IDs is unique to its particular port interface and each set of port-specific VLAN IDs is independent of the other set. VLAN ID translation rules are used to maintain the uniqueness of the VLAN traffic across the service provider edge device while accomplishing many different VLAN traffic patterns. For example, VLAN traffic can be aggregated from the customer side to the service provider side of the service provider edge device.

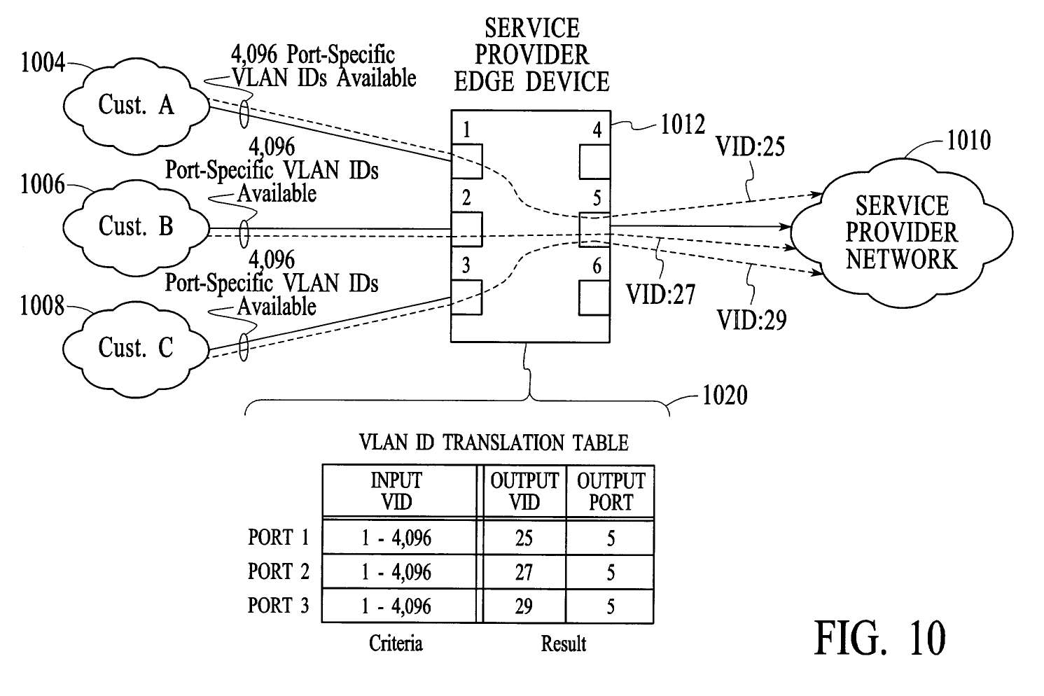

FIG. 10 depicts an example of VLAN traffic that is aggregated on a per-port, or per-customer, basis using VLAN ID translation. In the example, the service provider edge device aggregates all of the traffic received at a port to a single VLAN by translating all of the input VLAN IDs to a single output VLAN ID. For example, referring to the VLAN ID translation table 1020, at port interface 1, all of the port-specific input VLAN IDs (i.e., VLAN IDs1-4,096) are translated to a single output VLAN ID (i.e., VLAN ID 25) and the traffic is output on port interface 5. At port interface 2, all of the port-specific input VLAN IDs (i.e., VLAN IDs 1-4,096) are translated to a single output VLAN ID (i.e., VLAN ID 27) and the traffic is output on port interface 5. Likewise, at port interface 3, all of the port-specific input VLAN IDs (i.e., VLAN IDs 1-4,096) are translated to a single output VLAN ID (i.e., VLAN ID 29) and the traffic is output on port interface 5. This type of aggregation scheme may be used in situations where the service provider can treat all of the traffic from a particular customer the same. For example, all of the traffic from customer A 1004 can be forwarded through the service provider network on the same VLAN. As can be seen from FIG. 10, VLAN ID translation enables the service provider edge device 1012 to support the maximum available number of VLAN IDs at each port without losing the VLAN ID uniqueness that is needed to differentiate VLAN traffic within the service provider network. In the example of FIG. 10, the VLAN IDs used between the customer networks 1004, 1006, and 1008 and the service provider edge device 1012 are customer-defined VLAN IDs and the VLAN IDs used between the service provider edge device and the service provider network 1010 are service provider-defined VLAN IDs. Although a particular VLAN ID aggregation scheme is described with reference to FIG. 10, other aggregation schemes may be implemented.

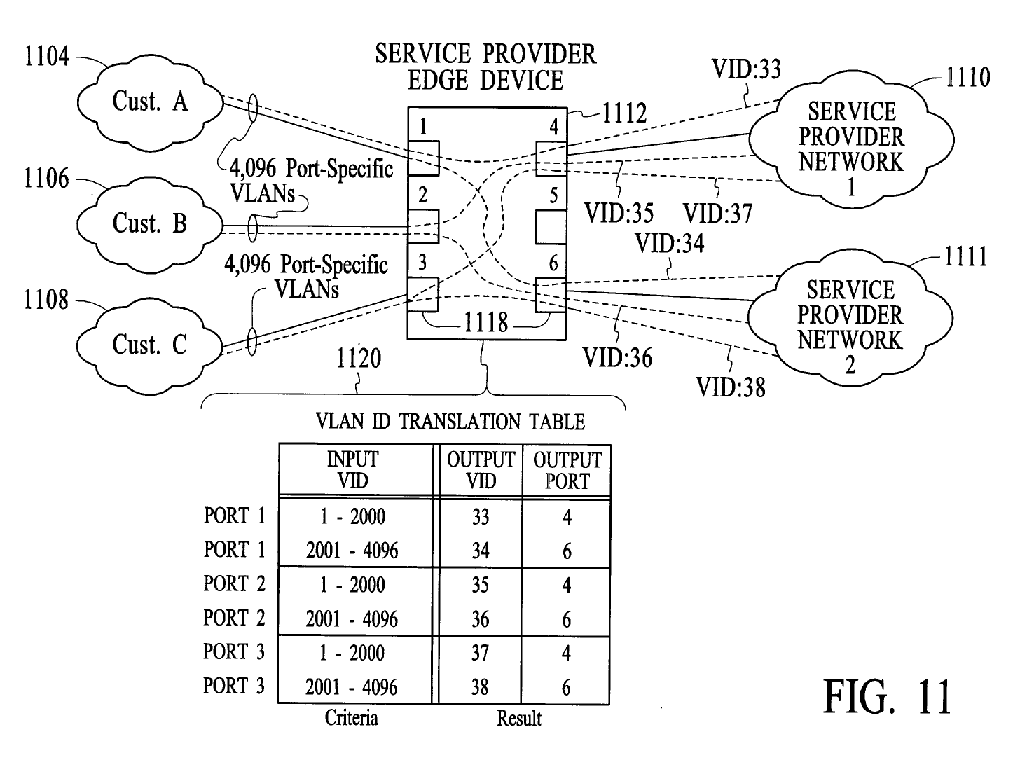

FIG. 11 depicts an example of VLAN traffic that is aggregated and segregated using VLAN ID translation. In the example, the service provider edge device 1112 aggregates traffic from an input port interference 1118 onto two different VLANs and then outputs the traffic from the two VLANs on different port interfaces. For example, referring to the VLAN ID translation table 1120 of FIG. 11, at port interface 1, input VLAN IDs 1-2,000 are translated to VLAN ID 33 and the traffic is output on port interface 4 and input VLAN IDs 2,001-4,096 are translated to VLAN ID 34 and the traffic is output on port interface 6. At port interface 3, input VLAN IDs 1-2,000 are translated to VLAN ID 35 and the traffic is output on port interface 4 and input VLAN IDs 2,001-4,096 are translated to VLAN ID 36 and the traffic is output on port interface 6. Likewise, at port interface 3, input VLAN IDs 1-2,000 are translated to VLAN ID 37 and the traffic is output on port interface 4 and input VLAN IDs 2,001-4,096 are translated to VLAN ID 38 and the traffic is output on port interface 6. This type of aggregation and segregation scheme may be used to direct different traffic types to different service provider networks. For example, voice traffic from customers A, B, and C may be supported through service provider network 1 1110 while data traffic from customers A, B, and C may be supported through service provider network 2 1111. As can be seen from FIG. 11, VLAN ID translation enables the service provider edge device 1112 to support the maximum number of available VLAN IDs at each port without losing the VLAN ID uniqueness. Although a particular VLAN ID aggregation and segregation scheme is described with reference to FIG. 11, other aggregation and segregation schemes may be implemented.

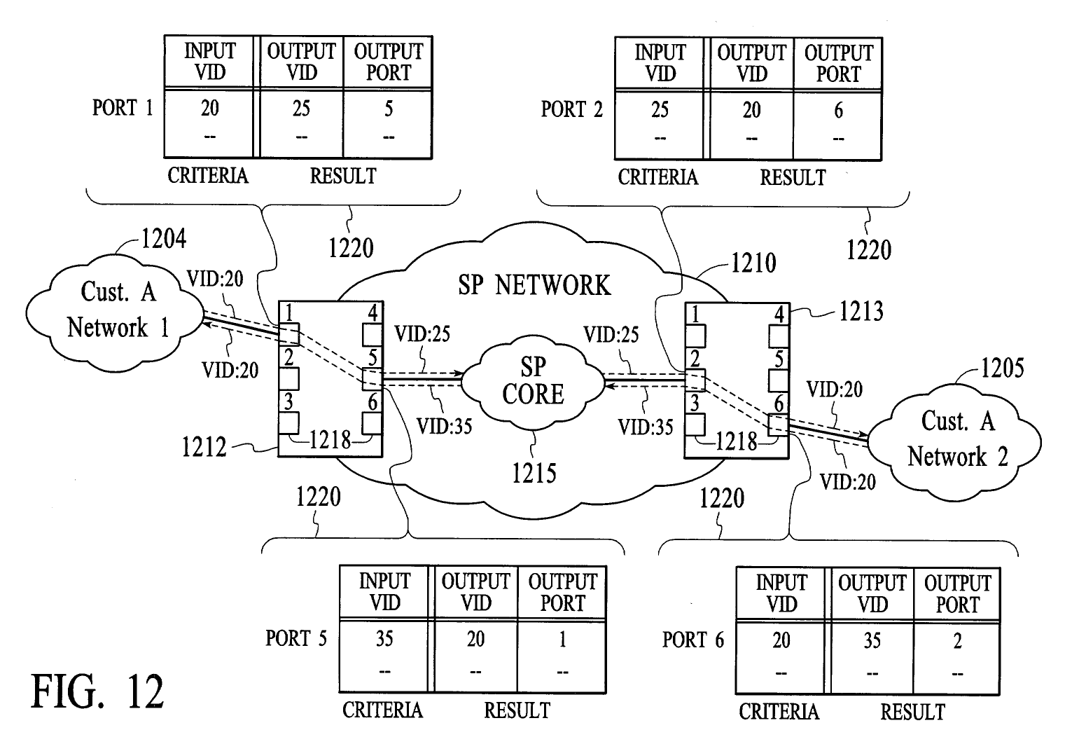

FIG. 12 depicts an example of an end-to-end VLAN implementation that is enabled via the VLAN ID translation techniques that are described above with reference to FIGS. 2-7. In the example of FIG. 12, a customer's VLAN traffic is tunneled through a service provider network 1210 (including the service provider network core 1216) using VLAN ID translation. Tunneling of the VLAN traffic through the service provider network using VLAN ID translation allows the customer to define its own VLAN IDs (customer-defined VLAN IDs) for traffic exchanged between the customer networks 1204 and 1205 and allows the service provider to define its own VLAN IDs (service provider-defined VLAN IDs) for traffic that is forwarded within the service provider network. In the example of FIG. 12, customer A desires to use the service provider network to send VLAN traffic between networks 1 and 2. For example, customer A sends VLAN traffic between networks 1 and 2 on VLAN ID 20. Within the service provider network, VLAN traffic from customer A is sent in one direction, from network 1 to network 2, on VLAN ID 25 and in the other direction, from network 2 to network 1, on VLAN ID 35. At least two VLAN ID translations are performed in each direction for traffic that is sent between customer A's networks.

For traffic going from customer network 1 1204 to customer network 2 1205, a first VLAN ID translation is performed at the input port interface (port interface 1) of service provider edge device 1112. The VLAN ID translation at port interface 1 involves translating input VLAN ID 20 to output VLAN ID 25 and output port interface 5 as indicated by the respective VLAN ID translation table 1220. Within the service provider network 1210, the traffic from network 1 to network 2 travels on VLAN ID 25. A second VLAN ID translation is provided at the input port interface (port interface 2) of service provider edge device 1213. The VLAN ID translation at port interface 2 involves translating input VLAN ID 25 to output VLAN ID 20 and output port interface 6 as indicated by the respective VLAN ID translation table. Traffic that is output from port interface 6 travels on VLAN ID 20, which is the customer-defined VLAN ID that the traffic was initially used by the customer at network 1.

For traffic going from customer network 2 1205 to network 1 1204, a first VLAN ID translation is performed at the input port interface (port interface 6) of service provider edge device 1213. The VLAN ID translation at port interface 6 involves translating input VLAN ID 20 to output VLAN ID 35 and output port interface 2 as indicated by the respective VLAN ID translation table 1220. Within the service provider network, the traffic from network 2 to network 1 travels on VLAN ID 35. A second VLAN ID translation is provided at the input port interface (port interface 5) of service provider edge device 1212. The VLAN ID translation at port interface 5 involves translating input VLAN ID 35 to output VLAN ID 20 and output port interface 1 as indicated by the respective VLAN ID translation table. Traffic that is output from port interface 1 travels on VLAN ID 20, which is the customer-defined VLAN ID that the traffic was initially used by the customer at network 2.

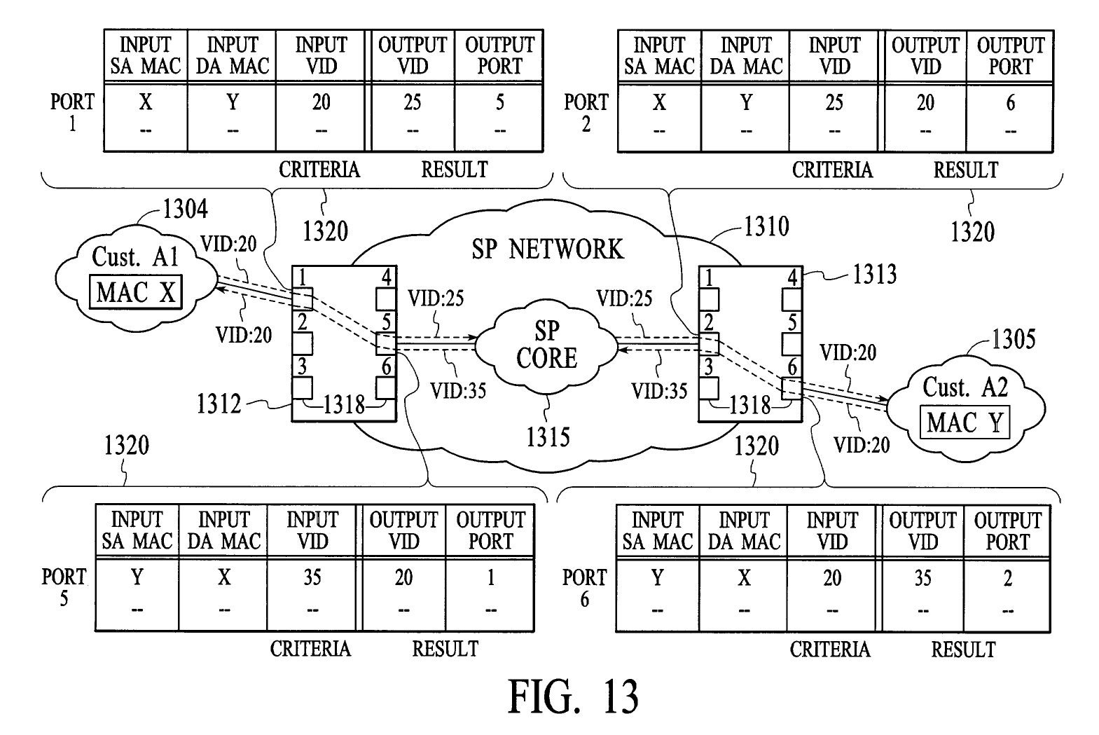

FIG. 13 depicts another example of an end-to-end VLAN implementation that is enabled via VLAN ID translation. The example of FIG. 13 is similar to the example of FIG. 12 except that VLAN ID translation is performed at a higher level of specificity. In the example of FIG. 13, VLAN ID translation is performed using the input VLAN ID, the input SA MAC, and the input DA MAC as search criteria for identifying the target output VLAN ID and output port interface. This implementation, referred to as “flow mode” VLAN ID translation enables a particular L2 flow of traffic to be forwarded from network 1 to network 2 of customer A using VLAN ID translation. In the “flow mode,” the hardware-based L2 forwarding table is programmed and searched based on the SA MAC, the DA MAC, and the input VLAN ID of the incoming VLAN traffic as indicated by the port-specific VLAN ID translation tables depicted in FIG. 13. In alternative embodiments, other combinations of criteria can be used to implement VLAN ID translation.

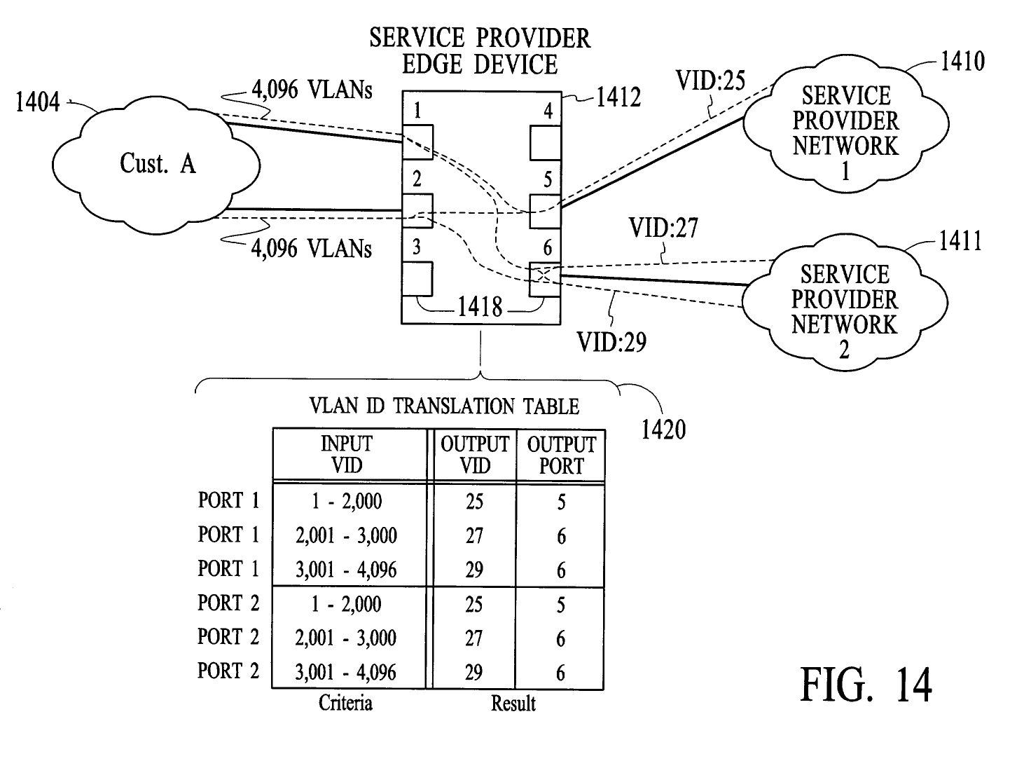

FIG. 14 depicts an example of how VLAN ID translation can be used to scale the number of unique VLAN IDs that are available between a customer network 1404 and a service provider edge device 1412. In the example, two physical connections are made between the customer network and the service provider edge device. Using VLAN ID translation, the maximum number of port-specific VLANs can be provisioned at each physical connection. Given two physical connections between the customer network and the service provider edge device, 8,192 VLANs with port-specific uniqueness can be provisioned. In the example of FIG. 14, the VLAN traffic is aggregated and segregated. The segregated traffic is then distributed to two different service provider networks 1410 and 1411. In the example, with regard to port interface 1, traffic from VLAN IDs 1-2,000 are translated to output VLAN ID 25 and output port 5, traffic from VLAN IDs 2,001-3,000 are translated to output VLAN ID 27 and output port 6, and traffic from VLAN IDs 3,001-4,096 are translated to output VLAN ID 29 and output port 6. Likewise, with regard to port interface 2, traffic from VLAN IDs 1-2,000 are translated to output VLAN ID 25 and output port 5, traffic from VLAN IDs 2,001-3,000 are translated to output VLAN ID 27 and output port 6, and traffic from VLAN IDs 3,001-4,096 are translated to output VLAN ID 29 and output port 6.

Although the ID translation techniques are described herein with reference to Ethernet-based VLAN IDs, the ID translation techniques can be implemented with other network technologies that enable virtual circuits (VCs), such as ATM or Frame Relay. For example, similar techniques can be used to translate an input ATM VC (for example, as identified by a VPI/VCI pair) to a different output ATM VC. Likewise, a Frame Relay DLCI can be translated to a different output DLCI. In addition, the VLAN traffic described herein can be any Ethernet, Ethernet compatible, IEEE 802.3, or IEEE 802.3 compatible frame format.

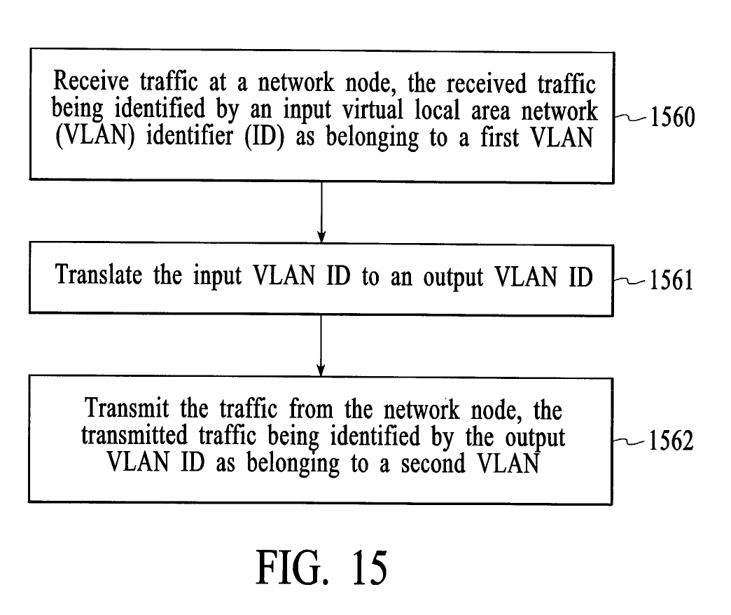

FIG. 15 is a process flow diagram of a method for forwarding traffic through a network node in accordance with an embodiment of the invention. At block 1560, traffic is received at a network node, the received traffic being identified by an input virtual local area network (VLAN) identifier (ID) as belonging to a first VLAN. At block 1561, the input VLAN ID is translated to an output VLAN ID. At block 1562, the traffic is transmitted from the network node, the transmitted traffic being identified by the output VLAN ID as belonging to a second VLAN.

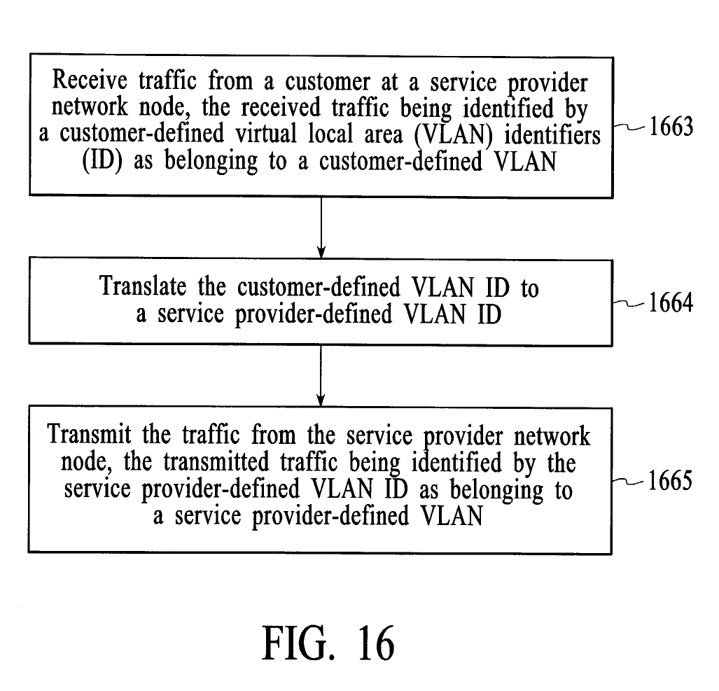

FIG. 16 is a process flow diagram of another method for forwarding traffic through a network node in accordance with an embodiment of the invention. At block 1663, traffic is received from a customer at a service provider network node, the received traffic being identified by a customer-defined virtual local area (VLAN) identifiers (ID) as belonging to a customer-defined VLAN. At block 1664, the customer-defined VLAN ID is translated to a service provider-defined VLAN ID. At block 1665, the traffic is transmitted from the service provider network node, the transmitted traffic being identified by the service provider-defined VLAN ID as belonging to a service provider-defined VLAN.

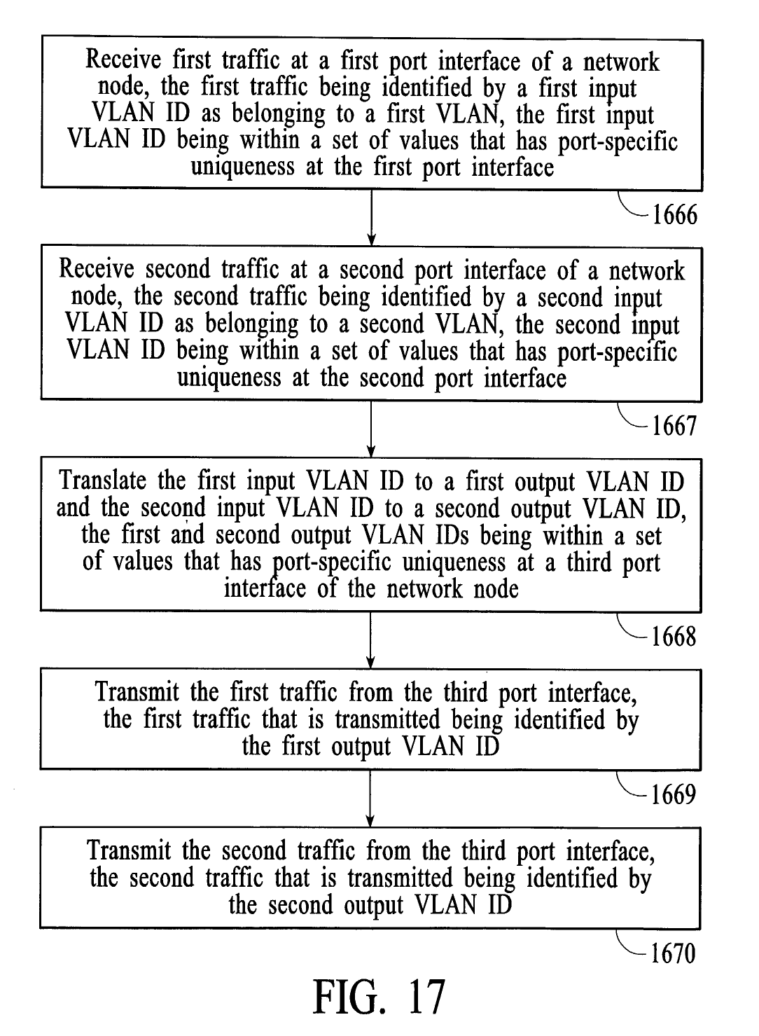

FIG. 17 is a process flow diagram of another method for forwarding traffic through a network node in accordance with an embodiment of the invention. At block 1666, first traffic is received at a first port interface of a network node, the first traffic being identified by a first input VLAN ID as belonging to a first VLAN, the first input VLAN ID being within a set of values that has port-specific uniqueness at the first port interface. At block 1667, second traffic is received at a second port interface of the network node, the second traffic being identified by a second input VLAN ID as belonging to a second VLAN, the second input VLAN ID being within a set of values that has port-specific uniqueness at the second port interface. At block 1668, the first input VLAN ID is translated to a first output VLAN ID and the second input VLAN ID is translated to a second output VLAN ID, the first and second output VLAN IDs being within a set of values that has port-specific uniqueness at a third port interface of the network node. At block 1669, the first traffic is transmitted from the third port interface, the first traffic that is transmitted being identified by the first output VLAN ID. At block 1670, the second traffic is transmitted from the third port interface, the second traffic that is transmitted being identified by the second output VLAN ID.

Although specific embodiments of the invention have been described and illustrated, the invention is not to be limited to the specific forms or arrangements of parts as described and illustrated herein. The invention is limited only by the claims.

What is claimed is:

1. A method for forwarding traffic through a network node comprising:
receiving traffic at said network node, said traffic that is received at said network node being identified by an input virtual local area network (VLAN) identifier (ID) as belonging to a first VLAN;
translating said input VLAN ID to an output VLAN ID; and
transmitting said traffic from said network node, said traffic that is transmitted from said network node being identified by said output VLAN ID as belonging to a second VLAN.

2. The method of claim 1 wherein said output VLAN ID is different from said input VLAN ID.

3. The method of claim 1 wherein said input VLAN ID is included within a first set of port-specific VLAN IDs and wherein said output VLAN ID is included within a second set of port-specific VLAN IDs.

4. The method of claim 3 wherein said first set of port-specific VLAN IDs is independent of said second set of port-specific VLAN IDs.

5. The method of claim 1 wherein said input VLAN ID has port-specific uniqueness that is specific to the port interface on which said traffic is received and wherein said output VLAN ID has port-specific uniqueness that is specific to the port interface on which said traffic is transmitted.

6. The method of claim 1 wherein translating said input VLAN ID to said output VLAN ID includes using said input VLAN ID as search criteria to identify said output VLAN ID.

7. The method of claim 6 wherein said traffic is received at an input port interface of said network node and transmitted from an output port interface of said network node.

8. The method of claim 7 further including using said input VLAN ID as search criteria to identify said output port interface.

9. The method of claim 8 further including programming a hardware-based look-up table that maps said input VLAN ID to said output VLAN ID and to said output port, and wherein said step of translating said input VLAN ID to said output VLAN ID includes accessing said hardware-based look-up table and using said input VLAN ID as search criteria.

10. The method of claim 8 further including establishing a static VLAN ID translation rule that maps said input VLAN ID to said output VLAN ID.

11. The method of claim 10 wherein said input VLAN ID is a customer-defined VLAN ID and wherein said output VLAN ID is a service provider-defined VLAN ID.

12. The method of claim 1 wherein translating said input VLAN ID to said output VLAN ID includes using said input VLAN ID and an identifier related to the port interface on which the traffic is received as search criteria to identify said output VLAN ID.

13. The method of claim 1 wherein translating said input VLAN ID to said output VLAN ID includes using a destination media access control (MAC) address of said received traffic as search criteria to identify said output VLAN ID.

14. The method of claim 1 wherein translating said input VLAN ID to said output VLAN ID includes using said input VLAN ID and a destination media access control (MAC) address as search criteria to identify said output VLAN ID.

15. The method of claim 1 wherein translating said input VLAN ID to said output VLAN ID includes using said input VLAN ID, a source media access control (MAC) address, and a destination MAC address as search criteria to identify said output VLAN ID.

16. The method of claim 1 further including programming a hardware-based look-up table that maps said input VLAN ID to said output VLAN ID, and wherein said step of translating said input VLAN ID to said output VLAN ID includes accessing said hardware-based look-up table and using said input VLAN ID as search criteria.

17. The method of claim 1 wherein translating said input VLAN ID to said output VLAN ID includes obtaining said input VLAN ID from 802.1Q headers of said received traffic and wherein said step of transmitting includes embedding said output VLAN ID into 802.1Q headers of outgoing traffic, wherein 802.1Q is a VLAN protocol that is defined by the IEEE.

18. The method of claim 1 further including establishing static VLAN ID translation rules that map input VLAN IDs to output VLAN IDs.

19. The method of claim 1 wherein said input VLAN ID is a customer-defined VLAN ID and wherein said output VLAN ID is a service provider-defined VLAN ID.

20. A network node comprising:
an input port interface configured to receive traffic, said traffic that is received at said input port interface being identified by an input virtual local area network (VLAN) identifier (ID) as belonging to a first VLAN;
a VLAN ID translation engine configured to translate said input VLAN ID to an output VLAN ID; and
an output port interface configured to transmit said traffic, said traffic that is transmitted from said output port interface being identified by said output VLAN ID as belonging to a second VLAN.

21. The network node of claim 20 wherein said output VLAN ID is different from said input VLAN ID.

22. The network node of claim 20 wherein said input port interface is associated with a first set of port-specific VLAN IDs and wherein said output port interface is associated with a second set of port-specific VLAN IDs, said first set of port-specific VLAN IDs being independent of said second set of port-specific VLAN IDs.

23. The network node of claim 20 wherein said VLAN ID translation engine includes a hardware-based table associated with said input port interface, said hardware-based table including a table entry that identifies said output VLAN ID and said output port interface as a function of said input VLAN ID.

24. The network node of claim 23 wherein said hardware-based table is searched as a function of said input VLAN ID and a destination media access control (MAC) address of said received traffic.

25. The network node of claim 20 wherein said VLAN ID translation engine maintains static VLAN ID translation rules that map input VLAN IDs to output VLAN IDs.

26. A method for forwarding traffic through a service provider network node that is connected to receive traffic from multiple customers, said method comprising:
receiving traffic from a customer at said service provider network node, said traffic that is received being identified by a customer-defined virtual local area (VLAN) identifier (ID) as belonging to a customer-defined VLAN;
translating said customer-defined VLAN ID to a service provider-defined VLAN ID; and
transmitting said traffic from said service provider network node, said traffic that is transmitted being identified by said service provider-defined VLAN ID as belonging to a service provider-defined VLAN.

27. The method of claim 26 further including establishing static VLAN ID translation rules that map customer-defined VLAN IDs to service provider-defined VLAN IDs.

28. The method of claim 26 wherein said input VLAN ID is unique among a first set of port-specific VLAN IDs and wherein said output VLAN ID is unique among a second set of port-specific VLAN IDs.

29. The method of claim 28 wherein said first set of port-specific VLAN IDs is independent of said second set of port-specific VLAN IDs.

30. The method of claim 26 wherein said customer-defined VLAN ID has port-specific uniqueness that is specific to a port interface on which said traffic is received and wherein said service provider-defined VLAN ID has port-specific uniqueness that is specific to a port interface on which said traffic is transmitted.

31. The method of claim 26 wherein translating said customer-defined VLAN ID to said service provider-defined VLAN ID includes using said customer-defined VLAN ID as search criteria to identify said service provider-defined VLAN ID.

32. The method of claim 26 wherein translating said customer-defined VLAN ID to said service provider-defined VLAN ID includes using said customer-defined VLAN ID and a destination media access control (MAC) address as search criteria to identify said service provider-defined VLAN ID.

33. A method for forwarding traffic through a network node using virtual local area networks (VLANs), wherein each VLAN is identified by a VLAN identifier (ID), each VLAN ID having a value within a set of values that is enabled by a fixed-length VLAN ID field, said method comprising:
receiving first traffic at a first port interface of said network node, said first traffic being identified by a first input VLAN ID as belonging to a first VLAN, said first input VLAN ID being within a set of values that has port-specific uniqueness at said first port interface;
receiving second traffic at a second port interface of said network node, said second traffic being identified by a second input VLAN ID as belonging to a second VLAN, said second input VLAN ID being within a set of values that has port-specific uniqueness at said second port interface;
translating said first input VLAN ID to a first output VLAN ID and said second input VLAN ID to a second output VLAN ID, said first and second output VLAN IDs being within a set of values that has port-specific uniqueness at a third port interface of said network node;
transmitting said first traffic from said third port interface, said first traffic that is transmitted being identified by said first output VLAN ID; and
transmitting said second traffic from said third port interface, said second traffic that is transmitted being identified by said second output VLAN ID.

34. The method of claim 33 wherein said first and second input VLAN IDs are customer-defined VLAN IDs and said first and second output VLAN IDs are service provider-defined VLAN IDs.

35. The method of claim 34 wherein said first input VLAN ID is defined by a first customer and said second input VLAN ID is defined by a second customer.

36. The method of claim 33 wherein translating said first and second input VLAN IDs to said first and second output VLAN IDs includes using said first and second input VLAN IDs as search criteria to identify said first and second output VLAN IDs.

37. The method of claim 36 wherein translating said first and second input VLAN IDs to said first and second output VLAN IDs includes using said first and second input VLAN IDs as search criteria to identify said first and second output VLAN IDs and said third port interface.

38. The method of claim 33 wherein translating said first input VLAN ID to a first output VLAN ID and said second input VLAN ID to a second output VLAN ID includes using said first input VLAN ID as search criteria to identify said first output VLAN ID and using said second input VLAN ID as search criteria to identify said second output VLAN ID.

39. The method of claim 33 wherein translating said first input VLAN ID to a first output VLAN ID and said second input VLAN ID to a second output VLAN ID includes using said first input VLAN ID and first destination media access control (MAC) address as search criteria to identify said first output VLAN ID and using said second input VLAN ID and second destination MAC address as search criteria to identify said second output VLAN ID.
